(19) United States
(12) Patent Application Publication
(10) Pub. No.: US 2025/0376409 A1
(43) Pub. Date: Dec. 11, 2025

(54) PROCESS TO PRODUCE MULTICORE OPTICAL FIBER PREFORM

(71) Applicant: CORNING INCORPORATED, CORNING, NY (US)

(72) Inventors: Kevin Wallace Bennett, Hammondsport, NY (US); Douglas Llewellyn Butler, Painted Post, NY (US); Rostislav Radiyevich Khrapko, Corning, NY (US)

(21) Appl. No.: 19/219,402

(22) Filed: May 27, 2025

Related U.S. Application Data
(60) Provisional application No. 63/657,268, filed on Jun. 7, 2024.

(51) Int. Cl. C03B 37/027

(52) U.S. Cl. CPC C03B 37/02718; C03B 2203/34

(57) ABSTRACT

A method of making a multicore optical fiber prefom, the method including heating a sleeve blank above its softening temperature and molding the heated sleeve blank within a mold to form a sleeve so that exterior surfaces of the sleeve assume the shape of the mold, the sleeve being formed of silica-based glass and the sleeve comprising a plurality of core cane holes extending within the sleeve. The method further including inserting a core cane through each of the core cane holes, the core canes being formed of silica-based glass and the core canes each comprising a core region.

This application claims the benefit of priority to U.S. Provisional Patent Application Ser. No. 63/657,268 filed on Jun. 7, 2024, the content of which is relied upon and incorporated herein by reference in its entirety.

### FIELD

This description pertains to multicore optical fiber preforms. More particularly, this description relates to a molding process to produce a multicore optical fiber preform and drawing of the preform to form multicore optical fibers.

### BACKGROUND

Optical fibers are utilized in a variety of telecommunication applications. The most widely used optical fibers include a single core element for transmission of optical signals. The core element of a single-core optical fiber includes a core region surrounded by one or more cladding regions. Since the transmission capacity of single-core optical fibers is currently approaching its theoretical limits, the demand for increased transmission capacity is currently being met through increases in the number of single-core optical fibers included in transmission cables. While a higher fiber count provides higher transmission capacity, it leads to larger cables and makes it difficult to retrofit existing space-constrained fiber installations with higher capacity cables. As a result, there is a need to develop solutions that provide higher transmission capacity without increasing the size of transmission cables.

One solution under consideration is multicore optical fibers. Multicore optical fibers include multiple core elements embedded in a common cladding. Each core element of a multicore optical fiber acts as an independent signal transmission channel. Since transmission capacity increases as the number of core elements in a multicore fiber increases, it is desirable to maximize the density of core elements in a given cross-sectional area of common cladding.

Multicore optical fibers are drawn from preforms that include multiple core canes positioned within a surrounding common cladding. Multicore optical fibers are formed by heating the tip of the preform and drawing fiber from it under tension. As fiber is drawn, it thins in diameter and cools. As the fiber cools, its viscosity increases and the fiber diameter stabilizes to a predetermined target (e.g., 125 microns).

Several methods are currently used to form preforms for multicore optical fibers. In one method, holes are drilled in a cylindrical glass body and core canes are placed into the holes to form a preform. But there is a need in the art to produce multicore optical fiber preforms with increased uniformity and precision. Such reduces any downstream machining of the preform and produces optical fibers with reduced manufacturing time and costs.

### SUMMARY

The present disclosure provides preforms and preform assemblies for multicore optical fibers and methods of making the same. The preforms have increased uniformity and precision and, in particular, have outer surfaces with reduced surface roughness. Such reduces any downstream manufacturing of the preforms, such as any grinding or polishing of the preforms, which advantageously reduces manufacturing time and costs. Thus, the preforms produced according to the embodiments disclosed herein provide fibers with optimal transmission features while reducing processing expenses.

According to a first aspect, a method of making a multicore optical fiber prefom, the method comprising heating a sleeve blank above its softening temperature and molding the heated sleeve blank within a mold to form a sleeve so that exterior surfaces of the sleeve assume the shape of the mold, the sleeve being formed of silica-based glass and the sleeve comprising a plurality of core cane holes extending within the sleeve, and inserting a core cane through each of the core cane holes, the core canes being formed of silica-based glass and the core canes each comprising a core region.

According to a second aspect, a method of making a multicore optical fiber prefom, the method comprising heating a sleeve blank above its softening temperature and molding the heated sleeve blank within a mold to form a sleeve so that exterior surfaces of the sleeve assume the shape of the mold, the sleeve being formed of silica-based glass, and forming a plurality of core cane holes within the sleeve.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale. Whenever possible, the same reference numeral will be used throughout the drawings to refer to the same or like feature.

The claims as set forth below are incorporated into and constitute part of this Detailed Description.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings.

FIG. 1 depicts a process to produce multicore optical fiber preforms, according to the embodiments disclosed herein;

FIG. 2A depicts a cross-sectional view of a core cane having a core region and a cladding region, according to the embodiments disclosed herein;

FIG. 2B depicts a cross-sectional view of a core cane having a core region, an inner cladding region, and a trench cladding region, according to the embodiments disclosed herein;

FIG. 3A depicts a relative refractive index profile of a core cane and an outer common cladding region, according to the embodiments disclosed herein;

FIG. 3B depicts another relative refractive index profile of a core cane and an outer common cladding region, according to the embodiments disclosed herein;

FIG. 4A is a schematic depiction of a soot deposition process to produce a core cane, according to the embodiments disclosed herein;

FIG. 4B depicts an apparatus for doping and consolidating a soot preform to form a core cane, according to embodiments disclosed herein;

FIG. 5 is a schematic depiction of a soot deposition process to produce a sleeve blank, according to the embodiments disclosed herein;

FIGS. 6A and 6B each depict a sleeve blank, according to the embodiments disclosed herein;

FIG. 7 depicts a cross-sectional view of a mold to form a preform, according to the embodiments disclosed herein;

FIGS. 8A-9 are each a schematic depiction of a molding process to form a preform, according to the embodiments disclosed herein;

FIG. 10 depicts a sleeve, according to the embodiments disclosed herein;

FIGS. 11A and 11B are schematic depictions of inserting core canes into core cane holes in a sleeve to form a preform, according to the embodiments disclosed herein;

FIG. 12 is a schematic depiction of a preform formed of a stacked sleeve assembly, according to the embodiments disclosed herein; and

FIG. 13 is a schematic diagram of an exemplary multicore optical fiber drawing system used to fabricate a multicore optical fiber, according to the embodiments disclosed herein.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are components (including materials, compounds, compositions, and method steps) that can be used for, in conjunction with, in preparation for, or as embodiments of the disclosed preforms and methods for making preforms and multicore optical fiber. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, selection of materials, orientations, etc.) without materially departing from the novel and nonobvious teachings and advantages of the subject matter recited.

In this specification and in the claims which follow, reference will be made to a number of terms which shall be defined to have the following meanings:
“Include,” “includes,” or like terms means encompassing but not limited to, that is, inclusive and not exclusive.

The indefinite article “a” or “an” and its corresponding definite article “the” as used herein means at least one, or one or more, unless specified otherwise.

The term “or,” as used herein, is inclusive; more specifically, the phrase “A or B” means “A, B, or both A and B.” Exclusive “or” is designated herein by terms such as “either A or B” and “one of A or B,” for example.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within +10% of the number. For example, a value that is about 10 refers to a value between 9 and 11, inclusive. When the term “about” is used in describing a value or an end-point of a range, the disclosure should be understood to include the specific value or end-point referred to.

As used herein, “comprising” is an open-ended transitional phrase. A list of elements following the transitional phrase “comprising” is a non-exclusive list, such that elements in addition to those specifically recited in the list may also be present.

The terms “comprising,” and “comprises,” e.g., “A comprises B,” is intended to include as special cases the concepts of “consisting of” and “consisting essentially of” as in “A consists of B” or “A consists essentially of B”.

The term “wherein” is used as an open-ended transitional phrase, to introduce a recitation of a series of characteristics of the structure.

As used herein, “contact” refers to direct contact or indirect contact. Direct contact refers to contact in the absence of an intervening material and indirect contact refers to contact through one or more intervening materials. Elements in direct contact touch each other. Elements in indirect contact do not touch each other but are rigidly or flexibly joined through one or more intervening materials. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Radial position”, “radius”, or the radial coordinate “r” refers to radial position relative to the centerline (r=0) of the core cane or corresponding core region in a multicore optical fiber drawn from a preform formed from the core canc.

The terms “inner” and “outer” are used to refer to relative values of radial coordinate or relative positions of regions of the core cane or core region in a multicore optical fiber, where “inner” means closer to the centerline of the core cane or core region in a multicore optical fiber than “outer”. An inner radial coordinate is closer to the centerline than an outer radial coordinate. An inner region is closer to the centerline than an outer region.

“Refractive index” refers to the refractive index at a wavelength of 1550 nm.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the core cane or multicore optical fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. A or 4% or %) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the core cane or multicore optical fiber, the parameter Δᵢ refers to the average value of relative refractive index in the region as defined by Δₐᵥₑ given in Eq. (2) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) for any radial position r as:

$$Δ \% = 100 \frac{( {n}^{2} - {n}_{ref}^{2} )}{2 {n}^{2}} \qquad ( 1 )$$

where n is the refractive index at the radial position r in the glass fiber, unless otherwise specified and n_{ref} is the refractive index of pure silica glass, unless otherwise specified. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ% (or “delta %) and its values are given in units of “%”, unless otherwise specified. Relative refractive index may also be expressed as Δ(r) or Δ(r) %. When referring to a specific region i of the core cane or core region of a multicore optical fiber, relative refractive index may also be expressed as Δᵢ, Δᵢ%, Δᵢ(r) or Δᵢ(r) %.

The average relative refractive index (A ave) of a region of the fiber is determined from Eq. (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

“Trench” or “trench region” or “trench cladding region” refers to the portion of the cladding surrounded by and directly adjacent to the outer cladding region. A trench is situated between the outer radius r₁ of the core region and the inner radius of the outer common cladding region and has a relative refractive index Δ₃, which is less than the relative refractive index Δ₄ of the outer common cladding region. In some embodiments, a trench is directly adjacent to the core region. In other embodiments, an offset, inner cladding region surrounds and is directly adjacent to the core region, and a trench cladding region surrounds and is directly adjacent to the inner cladding region, where the inner cladding region has a relative refractive index Δ₂ less than the relative refractive index Δ₁ of the core region and greater than the relative refractive index Δ₃ of the trench cladding region.

Reference will now be made in detail to illustrative embodiments of the present description.

The present disclosure provides preforms and preform assemblies for multicore optical fibers and methods of making the same. The preforms are made by forming a glass sleeve with core cane holes using a glass molding step. As discussed further below, the glass molding step comprises molding molten glass in a mold at elevated temperatures to produce the glass sleeve with the core cane holes disposed therein. Drawn core canes are then inserted into the core cane holes in the sleeve to form a multicore optical preform. Multicore optical fiber preforms produced with the glass molding process disclosed herein comprise uniform outer dimensions along with reduced cracks and defects in the glass. The preforms may then be drawn into multicore optical fibers.

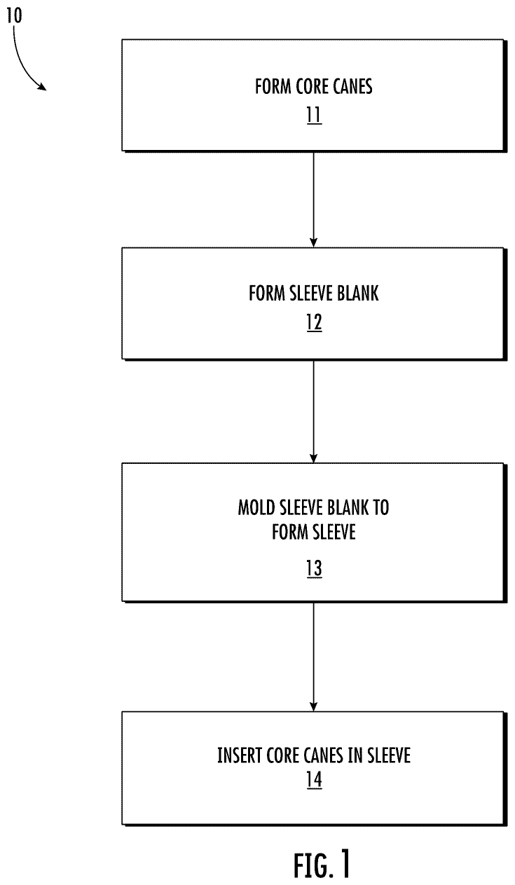

FIG. 1 is a process to produce multicore optical fiber preforms according to the embodiments of the present disclosure. As shown in FIG. 1, process 10 comprises forming core canes in step 11 and forming a sleeve blank in step 12. As discussed further below, the sleeve blank may comprise silica glass. In some embodiments, the sleeve blank may be a cylinder with core can holes formed therein or, in other embodiments, the sleeve blank may be a cylinder without such core cane holes. At step 13, the sleeve blank is molded into a sleeve. This step involves heating the sleeve blank to an elevated temperature so that the sleeve blank assumes the shape of the mold. As discussed further below, the mold comprises rods so that the glass of the heated sleeve blank flows around the rods within the mold to form core cane holes in the produced sleeve. The location of each rods corresponds to the location of each core can hole. The produced sleeve is then cooled. At step 14 of process 10, the core canes are inserted into the core cane holes of the cooled sleeve to form the final preform.

Step 13 of process 10 may also be referred to herein as a glass flowing step and/or a glass molding step in which the heated glass of the sleeve blank flows in and throughout the mold. This glass flowing/molding step occurs after consolidation of the sleeve blank in order to precisely mold the shape of the consolidated glass. Such allows the consolidated glass to assume the specific and precise shape of the mold in order to form a final sleeve with very uniform outer dimensions. Core canes may then be inserted within the final sleeve to produce a multicore optical fiber preform. Traditional methods to produce multicore optical preforms do not include such a glass flowing/molding step and, therefore, do not have such uniform outer dimensions.

It is noted that the steps of process 10 may be conducted in different orders and sequences than shown in FIG. 1. For example, step 11 of forming the core canes may be conducted after steps 12 and 13 of forming the sleeve.

Core canes are constituent elements of a preform. As in known in the art, core canes include a series of two or more concentric glass regions. The concentric glass regions become corresponding regions in multicore optical fibers drawn from the preforms. The core canes include a core region and a cladding region surrounding the core region. The core region and cladding region are each comprised of glass. The cladding region may include one or more regions that may differ in relative refractive index from the core region and each other. The multiple cladding regions are concentric with respect to each other and the core region. In embodiments, the cladding region includes a trench cladding region that surrounds the core region. In some embodiments, the trench cladding region is directly adjacent to the core region. In other embodiments, the trench cladding region is directly adjacent to an offset, inner cladding region and the inner cladding region is directly adjacent to the core region. The inner cladding region is optional and may also be referred to herein as an offset.

In an assembled multicore optical preform (in which multiple core canes are inserted within the sleeve), the concentric glass regions of the core canes are surrounded by the common outer cladding of the sleeve. The relative refractive index of the common outer cladding may differ from one or more relative refractive indices of the concentric glass regions of the core canes.

As is known in the art, the core region is the central region of the core cane and is substantially cylindrical in shape. It is also known in the art that a surrounding optional inner cladding region, a surrounding trench cladding region, and a surrounding outer common cladding region are each substantially annular in shape. Annular regions may be characterized in terms of an inner radius and an outer radius. Radial positions r₁, r₂, and r₃ refer herein to the outermost radii of the core region, inner cladding region, and trench cladding region, respectively. The outer radius of the sleeve corresponds to the outer radius of the multicore optical fiber preform.

Whenever used herein, relative refractive index Δ₁ or Δ₁(r) refer to the core region, relative refractive index Δ₂ or Δ₂(r) refer to the inner cladding region, relative refractive index Δ₃ or Δ₃(r) refer to the trench cladding region, and relative refractive index Δ₄ or Δ₄(r) refer to the outer common cladding region (the relative refractive index of the sleeve). Unless otherwise specified, if a single value is reported for the relative refractive index of a region, the single value corresponds to an average value for the region.

As will be described further hereinbelow, the relative refractive indices of one or more of the core region, inner cladding region, trench cladding region, and outer common cladding region differ from each other. Each of the regions is formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In embodiments, the undoped glass is pure silica glass. When the undoped glass is pure silica glass, updopants include Cl, Br, Ge, Al, P, Ti, Zr, Nb, and Ta, and downdopants include F and B. Regions of constant refractive index may be formed by not doping (e.g., pure silica) or by doping at a uniform concentration. Regions of variable refractive index are formed through non-uniform spatial distributions of dopants and/or through incorporation of different dopants in different regions. Refractive index varies approximately linearly with the concentration of the updopant or downdopant. For example, each 1 wt % Cl as a dopant in silica glass increases the relative refractive index by about 0.083% and each 1 wt % F as a dopant in silica glass decreases the relative refractive index by about 0.32%.

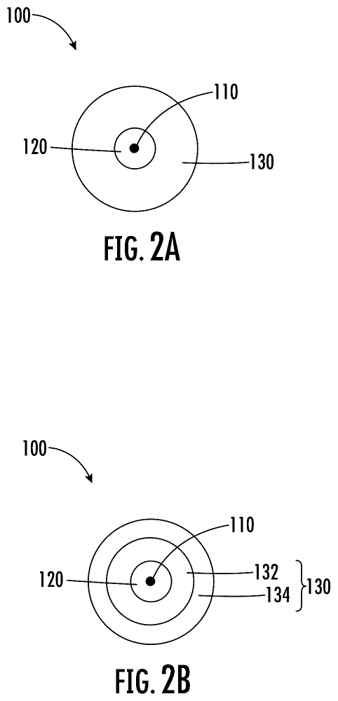

An example of a core cane 100 is shown in a schematic cross-sectional view in FIG. 2A. As shown in FIG. 2A, core cane 100 includes a core region 120 and a cladding region 130. Core region 120 has a higher refractive index than cladding region 130. In embodiments, cladding region 130 is a single region (e.g., trench cladding region) and in other embodiments, cladding region 130 includes multiple concentric regions (e.g., inner cladding region in combination with a trench cladding region). It is also noted that in some embodiments, core cane 100 only comprises core region 120 and does not comprise cladding region 130. In these embodiments, the core canes only comprise core region 120 without a cladding region. However, in these embodiments, the core region 120 of the core canes is still surrounded by the outer common cladding region of the sleeve. Each core cane 100 has a center 110 defining r=0 through which a centerline extending along the length of core cane 100 passes.

Another schematic cross-sectional depiction of core cane 100, according to some embodiments, is shown in FIG. 2B. In the embodiment of FIG. 2B, core cane 100 includes core region 120 and cladding region 130. In this embodiment, cladding region 130 includes an inner cladding region 132 and a trench cladding region 134. It is also noted in some embodiments, although not depicted, that cladding region 130 may only comprise inner cladding region 132 and not trench cladding region 134. Furthermore, in yet some other embodiments, cladding region 130 may comprise an outer cladding region (not depicted) between trench cladding region 134 and the outer common cladding region of the sleeve.

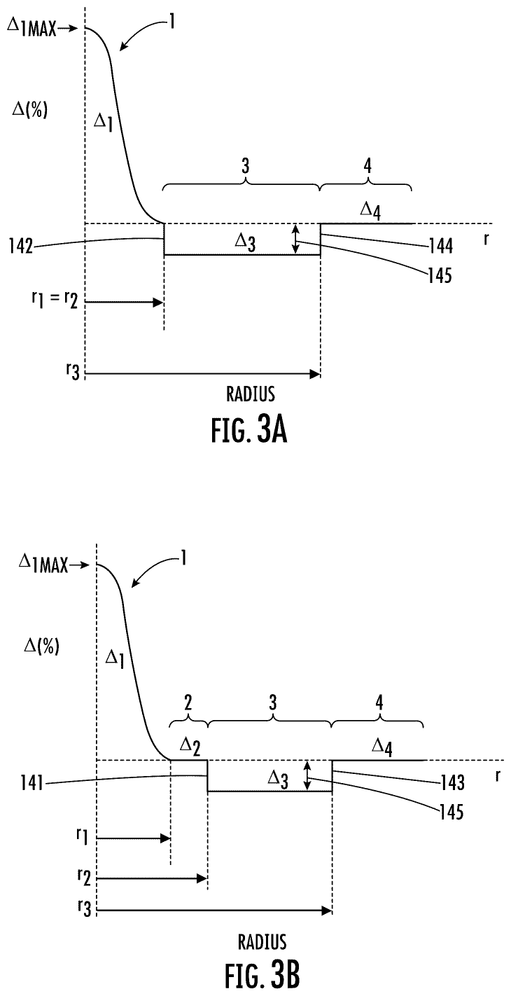

Representative relative refractive index profiles of multicore optical fibers produced form the multicore optical fiber preforms disclosed herein are presented in FIGS. 3A and 3B. Specifically, FIGS. 3A and 3B show the relative refractive index profiles with respect to the center 110 of an exemplary core cane in the multicore optical fiber. In FIG. 3A, core region (1) and trench cladding region (3) of the optical fiber depicted correspond to core cane 100 of the preform from which the optical fiber was produced. And outer common cladding region (4) of the fiber depicted corresponds to outer common cladding region 140 of the preform from which the optical fiber was produced. Furthermore, in FIG. 3B, core region (1), inner cladding region (2), and trench cladding region (3) of the optical fiber depicted correspond to core cane 100 of the preform from which the optical fiber was produced. And outer common cladding region (4) of the fiber depicted corresponds to outer common cladding region 140 of the preform from which the optical fiber was produced.

The core profiles in FIGS. 3A and 3B both have a graded relative refractive index profile. One type of optical fiber is a step-index optical fiber, which has a core region with a relative refractive index that is constant or approximately constant with radial position from the center 110 (r=0). Another type of optical fiber is a graded-index optical fiber, which has a core region with a relative refractive index that varies with radial position from the center 110 (r=0) of the optical fiber.

FIG. 3A shows an exemplary graded relative refractive index profile for the core region (1) with outer radius r₁ and relative refractive index Δ₁ with maximum relative refractive index Δ₁ₘₐₓ and a trench cladding region (3) extending from radial position r₂=r₁ to radial position r₃ and having relative refractive index Δ₃. In the embodiment of FIG. 3A, relative refractive index 43 is constant or approximately constant from inner radius r₂ of the trench cladding region (3) to the outer radius r₃ of the trench cladding region (3). In this embodiment, the fiber profile does not comprise an inner cladding region. The outer common cladding region (4) radially surrounds the trench cladding region (3) and has a relative refractive index Δ₄.

FIG. 3B shows an exemplary graded relative refractive index profile for the core region (1) with outer radius r₁ and relative refractive index Δ₁ with maximum relative refractive index Δ₁ₘₐₓ, an inner cladding region (2) extending from radial position r₁ to radial position r₂>r₁ and having relative refractive index Δ₂, and a trench cladding region (3) extending from radial position r₂ to radial position r₃ and having relative refractive index Δ₃. In the embodiment of FIG. 3B, relative refractive index Δ₃ is constant or approximately constant from inner radius r₂ of the trench cladding region (3) to the outer radius r₃ of the trench cladding region (3). The outer common cladding region (4) radially surrounds the trench cladding region (3) and has a relative refractive index Δ₄.

In other embodiments, core region (1) shown in FIGS. 3A and 3B is a step index relative refractive index profile instead of a graded relative refractive index profile. For example, the relative refractive index of the core region (1) may be a step-index profile having a constant or approximately constant value corresponding to Δ₁ₘₐₓ that extends over at least 70%, or at least 80%, or at least 90% of the distance between the center 110 of the optical fiber (r=0) and the outer radius r₁. In further embodiments, trench cladding region (3) shown in FIGS. 3A and 3B has a relative refractive index Δ₃ that varies in the radial direction.

In FIG. 3A, a transition region 142 from core region (1) to trench cladding region (3) and a transition region 144 from trench cladding region (3) to outer common cladding region (4) are each shown as step changes. In FIG. 3B, a transition region 141 from inner cladding region (2) to trench cladding region (3) and a transition region 143 from trench cladding region (3) to outer common cladding region (4) are each shown as step changes. However, it is to be understood that a step change is an idealization and that transition regions 141, 142, 143, 144 may not be strictly vertical in practice. Instead, transition regions 141, 142, 143, 144 may each have a slope or curvature. When transition regions 141, 142, 143, 144 are non-vertical, the inner radius (r₂) and outer radius (r₃) of trench cladding region (3) correspond to the mid-points of transition regions 142 and 144 and/or the mid-points of transition regions 141 and 143, respectively. The mid-points correspond to half of the depth 145 (FIGS. 3A and 3B) of the trench cladding region (3), where depth 145 is defined relative to relative refractive index Δ₄ of the outer common cladding region (4).

The relative ordering of relative refractive indices Δ₁, Δ₂, and 43 in the relative refractive index profile shown in FIGS. 3A and 3B satisfy the condition Δ₁ₘₐₓ>Δ₂>Δ₃. Furthermore, in embodiments, the relative ordering of relative refractive indices Δ₁, Δ₃, and Δ₄ in the relative refractive index profile shown in FIGS. 3A and 3B satisfy the condition Δ₁ₘₐₓ>Δ₄>Δ₃.

The core region (1) comprises silica glass. The silica glass of the core region is undoped silica glass, up-doped silica glass, and/or down-doped silica glass. In embodiments, the silica glass of the core region is Ge-free; that is the core region comprises silica glass that lacks Ge. In other embodiments, the core region comprises silica glass doped with germanium dioxide (GeO₂). Embodiments of up-doped silica glass include silica glass doped with an alkali metal oxide (e.g. Na₂O, K₂O, Li₂O, Cs₂O, or Rb₂O) and/or a halogen (Cl or Br). Down-doped silica glass includes silica glass doped with F.

The relative refractive index of each core region (1) may be described by an a-profile with an a value of about 7.0 or less, or about 6.0 or less, or about 5.0 or less, or about 4.0 or less, or about 3.0 or less, or about 2.0 or less, or about 1.0 or less. In some other embodiments, the a value is about 8.0 or greater, or about 9.0 or greater, or about 10.0 or greater, or about 11.0 or greater, or about 12.0 or greater, or about 13.0 or greater. In some embodiments, the core a value is about 10, or about 12, or about 20.

In embodiments, each core region (1) has a relative refractive index Δ₁ or Δ₁ₘₐₓ in a range from about 0.20% to about 2.00%, or from about 0.25% to about 1.90%, or from about 0.30% to about 1.80%, or from about 0.35% to about 1.70%, or from about 0.40% to about 1.60%, or from about 0.45% to about 1.50%, or from about 0.50% to about 1.40%, or from about 0.55% to about 1.30%, or from about 0.60% to about 1.20%, or from about 0.65% to about 1.10%, or from about 0.70% to about 1.00%, or from about 0.80% to about 0.90%, or any range encompassing any of these endpoints. The outer radius r₁ of each core region (1) is from about 2.5 microns to about 7.5 microns, or about 3.0 microns to about 7.0 microns, or about 3.5 microns to about 6.5 microns, or about 4.0 microns to about 5.0 microns, or about 3.0 microns to about 4.0 microns, or about 5.0 to about 6.5, or about 5.5 to about 6.3, or any range encompassing any of these endpoints.

Inner cladding region (2) may be comprised of un-doped silica glass. In other embodiments, inner cladding region (2) may be comprised of up-doped and/or down-doped silica glass. The relative refractive index Δ₂ of the inner cladding region (2) is in a range from about −0.10% to about 0.10%, or from about −0.05% to about 0.05%, or from about −0.02% to about 0.02%, or any range encompassing any of these endpoints. The relative refractive index Δ₂ is preferably constant or approximately constant. The outer radius r₂ of the inner cladding region (2) is from about 2.5 microns to about 15.0 microns, or about 3.0 microns to about 12.5 microns, or about 5.0 microns to about 10.0 microns, or about 6.0 microns to about 8.5 microns, or about 7.0 microns to about 8.0 microns, or any range encompassing any of these endpoints.

Trench cladding region (3) may be comprised of down-doped silica glass. In embodiments, the down-dopant in the trench cladding region (3) is F (fluorine) and/or boron (B). The relative refractive index Δ₃ or Δ₃ min of the trench cladding region (3) is in a range from about −0.70% to about −0.10%, or about −0.65% to about −0.15%, or about −0.60% to about −0.25%, or about −0.55% to about −0.30%, or any range encompassing any of these endpoints. The outer radius r₃ of the trench cladding region (3) is in a range from about 2.5 microns to about 28.0 microns, or about 4.0 microns to about 26.0 microns, or about 6.0 microns to about 24.0 microns, or about 8.0 microns to about 22.0 microns, or about 10.0 microns to about 22.0 microns, or about 12.0 microns to about 20.0 microns, or about 14.0 microns to about 23.0 microns, or any range encompassing any of these endpoints.

Outer common cladding region (4) may be comprised of un-doped silica glass. In other embodiments, outer common cladding region (4) may be comprised of up-doped and/or down-doped silica glass. In embodiments, outer common cladding region (4) is down-doped with F (fluorine). The relative refractive index Δ₄ or Δ₄ₘₐₓ of the outer common cladding region (4) is in a range from about −0.60% to about 0.10% or about −0.50% to about 0.00%, or about −0.40% to about −0.05%, or about −0.30% to about −0.10%, or about −0.20% to about −0.10%, or about −0.10% to about 0.10%, or about −0.05% to about 0.05%, or about −0.02% to about 0.02%, or about 0.00% to about 0.02% m or any range encompassing any of these endpoints. The relative refractive index Δ₄ is preferably constant or approximately constant. In embodiments, the relative refractive index Δ₄ of the outer common cladding region (4) is equal to or substantially equal to the relative refractive index Δ₂ of the inner cladding region (2). In other embodiments, the relative refractive index Δ₄ of the outer common cladding region (4) is different from the relative refractive index Δ₂ of the inner cladding region (2). The outer radius of the common outer cladding region (4) is in a range from about 25.0 microns to about 150.0 microns, or from about 30.0 microns to about 125.0 microns, or from about 40.0 microns to about 115.0 microns, or from about 50.0 microns to about 100.0 microns, or from about 60.0 microns to about 90.0 microns, or from about 70.0 microns to about 80.0 microns, or any range encompassing any of these endpoints. In some embodiments, the outer radius of the common outer cladding region (4) is about 62.5 microns.

As discussed above, the outer common cladding region (4) may be an outer cladding that is common to all core regions (1) in the multicore optical fiber. Thus, the outer common cladding region (4) surrounds each core region (1).

With reference again to FIG. 1, the multicore optical fiber preforms (which produce the multicore optical fibers with the profiles depicted in FIGS. 3A and 3B) are comprised of core canes inserted within core cane holes of a sleeve. In step 11 of process 10 of FIG. 1, the core canes may be formed by first producing a larger core cane blank and then redrawing the core cane blank to reduce the size of the core cane blank to the dimensions described herein for the core canes. The large core cane blank may consist of the same concentric regions as the core canes but with larger dimensions. More specifically, the core cane blank includes a central core region surrounded by an annular cladding region. The composition of the core and cladding regions of the core cane blank correspond to the compositions of the core and cladding regions of core canes redrawn from the core cane blank. The diameter of the core region of the core cane blank and the thickness of the cladding region of the core cane blank are in proportion to the core region diameter and cladding region thickness of core canes drawn from the core cane blank.

When the core canes are inserted into the core cane holes in a sleeve to produce a multicore optical fiber preform, the preform is then drawn to form a multicore optical fiber. When drawing the preform, each core cane in the preform becomes a core of the multicore optical fiber. The core region diameter and cladding thickness of the core are in proportion to the core region diameter and cladding region thickness of the core cane of the preform from which the core was drawn. The shape of the cross-section defined by the outer surface of the multicore optical fiber is similarly in proportion to the shape of the cross-section defined by the exterior surface of the preform from which the multicore optical fiber was drawn.

The core cane blanks, which form the core canes, comprise silica or silica-doped glass and can be produced by methods known in the art. Suitable methods include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot method, and doped deposited silica processes. A variety of CVD (chemical vapor deposition) and plasma-enhanced CVD processes are known and are suitable for producing silica or doped silica core cane blanks.

Formation of silica for the core cane blanks occurs through reaction or decomposition of a silica precursor. Suitable precursors for silica include OMCTS (octamethylcyclotetrasiloxane) and SiCl₄. Doping is accomplished with a doping precursor. The doping precursor can be introduced with the silica precursor in the deposition process or used to treat a silica body formed from the silica precursor. Preferred doping precursors include halogen-containing gases. Suitable precursors for doping silica with bromine include SiBr₄. Suitable precursors for doping silica with chlorine include Cl₂, SiCl₄, Si₂Cl₆, Si₂OCl₆, and CCl₄. Suitable precursors for doping silica with fluorine include F₂, CF₄, and SiF₄. The silica precursor and/or doping precursor is preferably provided as a gas to the deposition process. The gas phase silica precursor or gas phase doping precursor is supplied undiluted or in combination with an inert diluent gas (e.g., He, N₂, Ar).

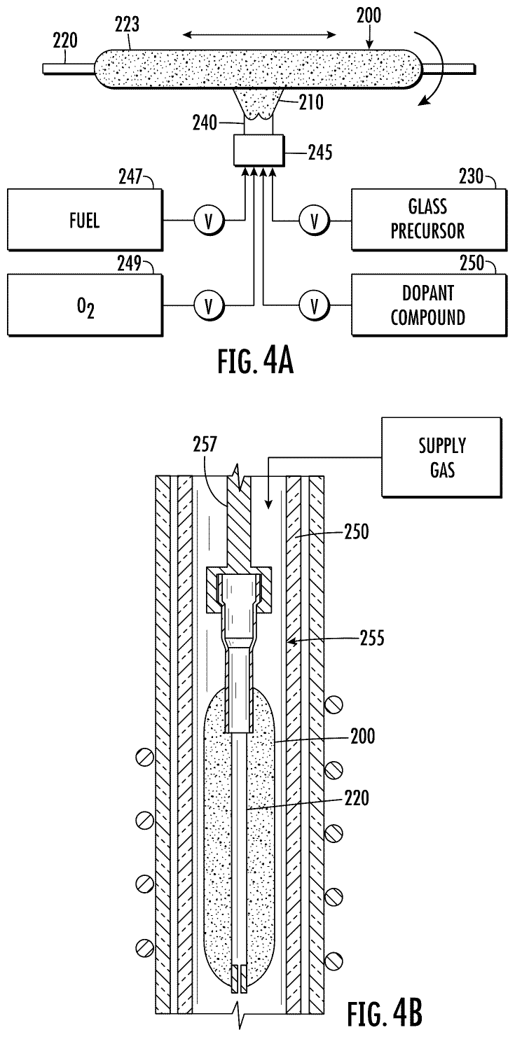

The core cane blank is made by forming the core region and cladding regions in one or more process steps. Typical process steps include soot deposition, doping, and consolidation. By way of illustration and not intended to be limiting, formation of a silica or doped silica in the form of a core soot body according to OVD methods is illustrated in FIGS. 4A and 4B. In FIG. 4A, core soot body 200 is formed by depositing silica-containing soot 210 onto the outer surface of a rotating and translating bait rod 220. In embodiments, bait rod 220 is tapered. The soot 210 for core soot body 200 is formed by providing a glass/soot precursor 230 in gaseous form to the flame 240 of a burner 245 to oxidize, hydrolyze, combust, or otherwise react or decompose the precursor 230. Fuel 247, such as methane (CH₄), and a combustion supporting gas 249, such as oxygen, are provided to the burner 245 and ignited to form the flame 240. A dopant compound 250 is also optionally provided to the burner 245. Mass flow controllers, labelled V, meter the appropriate amounts of glass/soot precursor 230, fuel 247, combustion supporting gas 249, and dopant compound 250, all preferably in gaseous form, to the burner 245. The glass/soot precursor 30 is a glass former compound (e.g., silica precursor) and is oxidized in the flame 245 to form a generally cylindrical core soot region 223.

FIG. 4B illustrates another process for doping and consolidating core soot body 200. Prior to consolidation, the bait rod 220 becomes integrated with the core soot body 200. During the doping and consolidation process, the core soot body 200 is suspended, for example, inside a pure quartz muffle tube 250 of a furnace 255 by a holding mechanism 257. Prior to or during the consolidation step, the core soot body 200 is optionally exposed to a doping precursor. The doping precursor is preferably provided in gas-phase form and is supplied directly to core soot body 200 before or during consolidation. In one embodiment, the gas-phase doping precursor is a vapor formed by heating or evaporating a liquid precursor. The doping precursor is supplied neat (undiluted) or in combination with a diluent gas. The doping concentration can be controlled by controlling, without limitation, the temperature of doping, the temperature of vaporization of a liquid doping precursor, the pressure or partial pressure of a gas-phase doping precursor in the processing ambient of the core soot body, time of doping, number of doping cycles, and the porosity or surface area of the core soot body (high porosity and/or high surface area promote higher doping concentrations).

In one embodiment after doping, the core soot body 200 is consolidated to form densified glass with the composition and refractive index profile of the core region 120 of the core cane 100. Typical temperatures of consolidation are in the range from about 1100° C. to about 1600° C. The densified glass has a density of at least about 1.90 g/cm³, in embodiments. After densification, the densified core glass is optionally redrawn to desired dimensions and is used as a substrate for depositing additional concentric soot layers having the composition and relative refractive index of the cladding region 130 of the core cane 100. Alternatively, the additional concentric soot cladding layers can be deposited on the core soot body 200 before consolidation and the combination of layers can be consolidated to form a core cane blank from which core canes are redrawn.

With reference again to FIG. 1, the sleeve blank is formed at step 12. Similar to the formation of the core canes as discussed above, the sleeve blank may also be formed by various methods including flame combustion methods, flame oxidation methods, flame hydrolysis methods, OVD (outside vapor deposition), IVD, VAD, double crucible methods, rod-in-tube procedures, cane-in-soot method, and doped deposited silica processes.

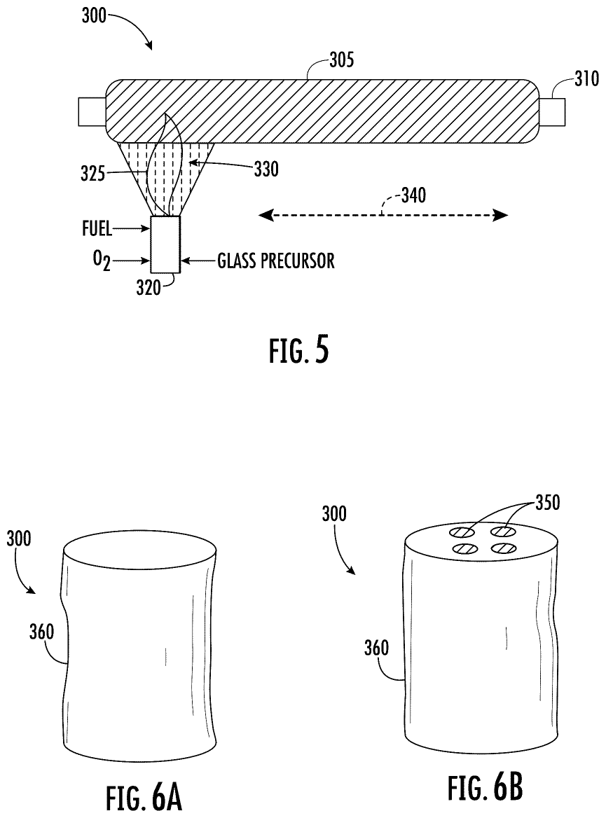

FIG. 5 illustrates one exemplary method to produce a sleeve blank. As shown in FIG. 5, the sleeve blank 300 is produced by the deposition of layers of silica-based soot 305 on a substrate 310. The silica-based glass soot 305 is formed by providing a vapor phase silica-based glass precursor material, such as SiCl₄ or octamethylcyclotetrasiloxane (OMCTS), to a burner 320. The gas-fed burner 320 is supplied with fuel, such as H₂, CH₄, D₂ (deuterium), CD₄ or CO. Oxygen is also provided to burner 320 and the fuel and oxygen are combusted to create flame 325. In some embodiments, the vapor phase silica-based glass precursor material is SiCl₄ and the gas-fed burner 320 is supplied with a non-hydrogenated fuel such as D₂, CD₄ or CO to limit the amount of residual OH in the deposited silica-based glass soot. The vapor phase silica-based glass precursor material may be delivered to the burner at a flow rate from about 4 L/min to about 10 L/min, while the fuel may be supplied to the burner at a flow rate from about 10 L/min to about 40 L/min.

The vapor phase silica-based glass precursor material is reacted in the flame 325 to produce silica-based glass soot 330, which is deposited as layers of soot 305 on substrate 310 as the bait rod is rotated. The rotation rate may be from about 20 rpm to about 400 rpm, or preferably from about 30 rpm to about 100 rpm. Soot 305 may have the same, higher, or lower refractive index than undoped silica. Higher or lower refractive indices may be achieved by supplying an updopant or downdopant precursor to burner 320. Soot 305 may constitute a single-layer soot cladding monolith or may constitute the innermost (smallest radius) layer of a multilayer soot cladding monolith. The flame 325 of the gas-fed burner 320 is traversed back and forth along the axial length of the substrate 310 as indicated by arrow 340 as the bait rod is rotated thereby building up silica-based glass soot and forming the layers of soot 305 on the substrate 120.

Once sufficient layers of soot 305 are deposited on substrate 310, the soot 305 is consolidated to form sleeve blank 300. As shown in FIG. 6A, in embodiments, the sleeve blank 300 may be a cylindrical member. In yet some additional embodiments, as shown in FIG. 6B, precursor core cane holes 350 are drilled through the sleeve blank 300. At this point, sleeve blank 300 may have non-uniform and wavy outer surfaces 360. For example, outer surfaces 360 may be undulating or curving surfaces, at least in part along a portion of outer surfaces 360. Step 13 of process 10 corrects any such non-uniformity in outer surfaces 360 to provide a final sleeve with more uniform and non-wavy surfaces.

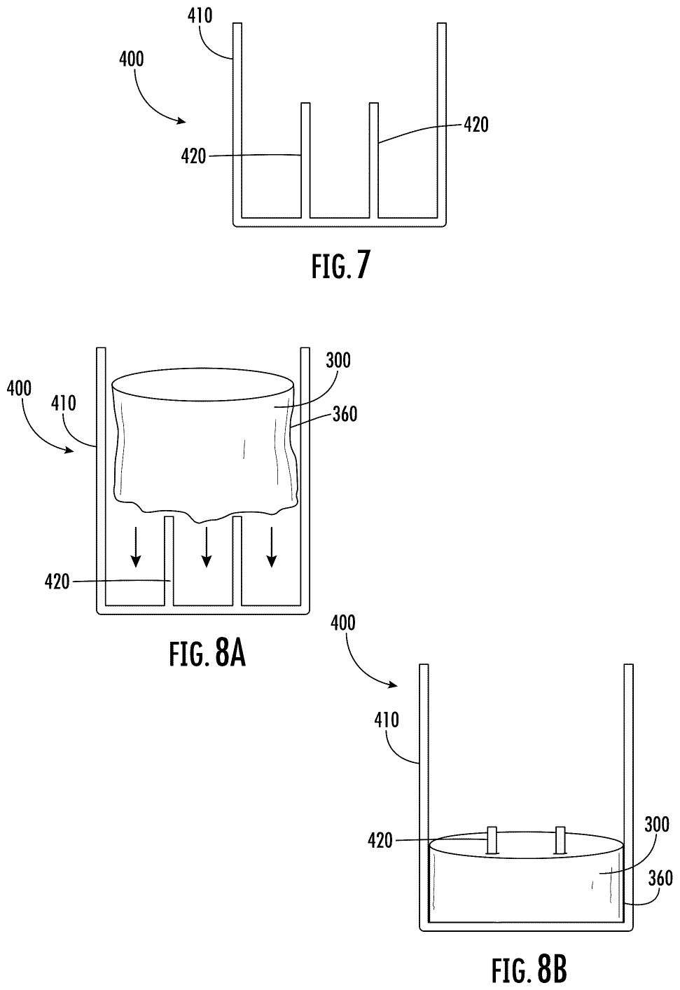

At step 13 of process 10, the consolidated sleeve blank 300 is molded to form a sleeve with more uniform outer dimensions. More specifically, step 13 comprises heating the sleeve blank 300 to a molten state so that the molten glass assumes the shape of the mold. As discussed further below, in embodiments, the sleeve blank 300 is heated to the molten state within the mold. In other embodiments, the sleeve blank 300 is heated to the molten state prior to being disposed within the mold. FIG. 7 shows a cross-sectional schematic of an exemplary mold 400. In some embodiments, mold 400 is a furnace. Mold 400 may comprise an interior housing 410 that houses and holds the molten glass. Interior housing 410 may be comprised of refractory materials such as graphite and/or a ceramic material such as zirconia, zirconium silicate, silicon carbide, and/or alumina. In embodiments, interior housing 410 may be lined or coated with one or more layers of material. The interior shape of housing 410 may correspond to the exterior shape of the final sleeve. Mold 400 may also comprise a plurality of rods 420, which may be comprised of the same material as interior housing 410. The number of rods 420 corresponds to the number of core canes to be inserted within the produced sleeve. FIG. 7 depicts two rods 420 to form a sleeve with two core cane holes, however, more rods 420 may be used. It is also contemplated, as discussed further below, that mold 400 may not comprise rods 420 or that rods 420 may have other shapes and configurations than depicted in FIG. 7. For example, in other embodiments, rods 420 are not attached to a bottom portion of mold 400, as shown in FIG. 7 and, instead, are lowered into the interior of mold 400. It is also contemplated in the embodiments disclosed herein that mold 400 may comprise other shapes and configurations than the cylindrical configuration shown in FIG. 7. For example, mold 400 may comprise a conical portion, as discussed further below.

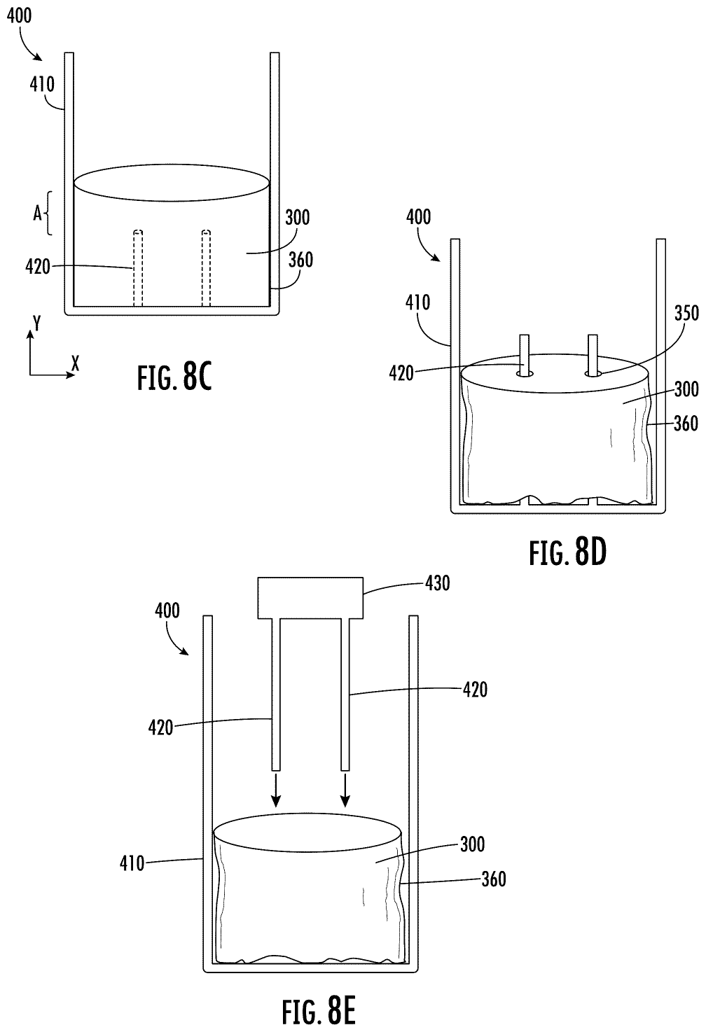

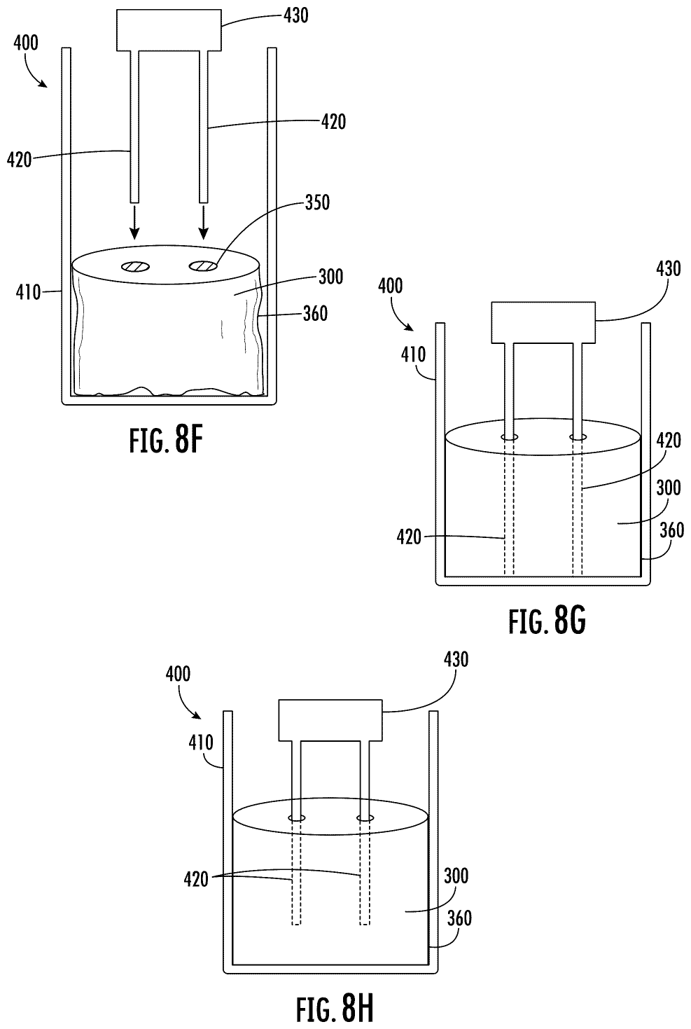

In embodiments, during step 13 of process 10 and as shown in FIG. 8A, sleeve blank 300 is positioned within mold 400 and then heated to a temperature above the softening point of the glass within mold 400. When sleeve blank 300 is formed of fused silica glass, whose softening point is about 1650° C., the glass is heated to a temperature in the range of about 1700° C. and greater, or about 1750° C. and greater, or about 1800° C. and greater, or about 1850° C. and greater, or about 1900° C. and greater, or about 1950° C. and greater, or about 2000° C. and greater. Additionally or alternatively, when sleeve blank 300 is formed of fused silica glass, the glass is heated to a temperature in the range of about 2000° C. and less, or about 1950° C. and less, or about 1900° C. and less, or about 1850° C. and less, or about 1800° C. and less, or about 1750° C. and less, or about 1700° C. and less. In embodiments, the glass is heated to a temperature from about 1700° C. to about 2000° C., or about 1750° C. to about 1950° C., or about 1800° C. to about 1900° C. It is noted that the temperature of the molten glass should not be too high so that the viscosity of the glass becomes too low. In such cases, the molten glass flows too freely in all directions. Instead, the temperature of the molten glass should be within the above-disclosed ranges so that the movement of the molten glass within interior housing 410 can be controlled.

In the embodiments in which sleeve blank 300 is heated within mold 400, mold 400 is also heated to a temperature within the above-disclosed ranges to heat and melt the glass of sleeve blank 300. By heating the glass of sleeve blank 300, the glass transitions to a relatively more liquid state so that the melted glass moves within interior housing 410 and assumes the shape of interior housing 410. Because the internal surfaces of interior housing 410 are smooth and uniform, the heated sleeve blank 300 also assumes such smooth and uniform surfaces. More specifically, outer surfaces 360 of sleeve blank 300 assume the smoothness and uniformity of the internal surfaces of interior housing 410.

As shown in FIG. 8A, sleeve blank 300 may initially be disposed within mold 400 such that sleeve blank 300 is positioned above and resting upon rods 420 of mold 400. As the glass of sleeve blank 300 is heated above its softening point within mold 400, the glass melts and flows within interior housing 410 and within the spaces between rods 420. After the melted glass has flown around rods 420 and has assumed the shape of interior housing 410, the rods 420 extend through the sleeve blank 300.

FIG. 8B shows sleeve blank 300 after it has been melted within mold 400 and assumed the shape (or partial shape) of interior housing 410. As shown in FIG. 8B, the rods 420 extend through sleeve blank 300. Once sleeve blank 300 has been cooled and removed from mold 400, the location of rods 420 within sleeve blank 300 forms core cane holes in the produced sleeve. Therefore, a diameter of the rods is substantially the same as a diameter of the produced core cane holes.

FIG. 8C similarly shows sleeve blank 300 after it has been melted within mold 400 and assumed the shape of interior housing 410. However, in this embodiment, a length of sleeve blank 300 in the y direction is greater than a length of rods 420 in the y direction. Therefore, the melted and cooled sleeve blank 300 is longer than rods 420 by a distance A.

FIG. 8D depicts another embodiment that is similar to the embodiment of FIG. 8A in which sleeve blank 300 is heated above its softening point within mold 400. However, in the embodiment of FIG. 8D, sleeve blank 300 comprises precursor core cane holes 350 already drilled therein. Therefore, sleeve blank 300 may be positioned within mold 400 such that rods 420 are positioned within precursor core cane holes 350. Sleeve blank 300 may then be heated above its softening point as discussed above so that the glass of sleeve blank 300 assumes the interior shape of interior housing 410. It is noted that precursor core cane holes 350 may be roughly or imprecisely formed within sleeve blank 300. After sleeve blank 300 is melted and molded within mold 400, precursor core cane holes 350 may be molded around the shape of rods 420 to produce more uniform and smooth core cane holes in the final produced sleeve.

In some embodiments, holes are formed in sleeve blank 300 quickly and cheaply to form the relatively more rough and less precise precursor core cane holes 350. In embodiments, precursor core cane holes 350 are drilled in sleeve blank 300. By molding sleeve blank 300 within mold 400 and around rods 420, the precursor core cane holes 350 may be molded into holes that are relatively less rough and more precise due to the molding of the precursor core cane holes 350 around rods 420. Furthermore, the produced core cane holes in the final sleeve may be relatively smaller than the precursor core cane holes 350. It is also noted that rods 420 (and the entire mold 400) may be used again with subsequent sleeve blanks 300 to produce more optical fiber preforms.

It is also contemplated in embodiments that sleeve blank 300 comprises precursor core cane holes 350 already drilled therein and that the precursor core cane holes 350 do not extend through an entire length of sleeve blank 300. For example, the embodiment shown in FIG. 8D may also comprise wherein precursor core cane holes 350 extend for a length less than a total length of sleeve blank 300 (and that rods 420 also extend for a length less than a total length of sleeve blank 300). Therefore, in these embodiments, rods 420 are positioned in precursor core cane holes 350 predrilled in sleeve blank 300 such that both rods 420 and precursor core cane holes 350 are shorter than a total length of sleeve blank 300.

FIG. 8E shows another embodiment in which sleeve blank 300 is positioned within mold 140 and then heated. As the glass is heated, a support 430 that is connected to rods 420 is lowered within mold 400 towards sleeve blank 300. As rods 420 are lowered, they puncture through the heated glass of sleeve blank 300 to form the core cane holes within the final produced sleeve. In the embodiment of FIG. 8E, rods 420 are moveable with regard to interior housing 410 and/or interior housing 410 is moveable with regard to rods 420. For example, support 430 (and, thus, rods 420) may be connected to a movement mechanism (not shown) to move support 430 and rods 420 with regard to housing 410. Alternatively, housing 410 may be connected to a movement mechanism (not shown) to move housing 410 relative to support 430 and rods 420.

As shown in FIG. 8F, it is also contemplated that support 430 may be used in embodiments in which sleeve blank 300 comprises precursor core cane holes 350 already drilled therein. In these embodiments, support 430 may lower rods 420 into and through precursor core cane holes 350 drilled within sleeve blank 300. In some embodiments, support 430 may first lower rods 420 into and through precursor core cane holes 350 predrilled within sleeve blank 300 and then, after such positioning of rods 420 within precursor core cane holes 350, the glass of sleeve blank 300 may be heated above its softening point within mold 400. It is also contemplated, in other embodiments, that the glass of sleeve blank 300 is first heated before rods 420 are lowered into precursor core cane holes 350. In embodiments, support 430 may comprise or be attached to an alignment mechanism (not shown) to evenly align rods 420 within mold 410 and/or to evenly align rods 420 with regard to sleeve blank 300. In embodiments, the alignment mechanism may align rods 420 within precursor core cane holes 350 of sleeve blank 300.

FIG. 8G shows sleeve blank 300 after it has been melted within mold 400 and assumed the shape of interior housing 410. As shown in FIG. 8F, the rods 420 have been lowered via support 430 into sleeve blank 300 and now extend through sleeve blank 300 to from the core cane holes. In this embodiment, the rods 420 extend at least an entire length of sleeve blank 300.

FIG. 8H shows a similar embodiment to that of FIG. 8G except in FIG. 8H, the rods 420 extend for less than an entire length within sleeve blank 300. Therefore, the core cane holes produced from rods 420 also extend for less than an entire length of sleeve blank 300.

In some embodiments, in which rods 420 extend for less than the entire length within sleeve blank 300, a portion of sleeve blank 300 through which rods 420 are not positioned may be formed into a conical shape. For example, FIG. 8I shows an exemplary embodiment in which a portion 345 of sleeve blank 350, that does not comprise rods 420 extending therethrough, is formed into a conical shape. In these embodiments, mold 400 may comprise such a conical shape at, for example, a bottom portion of mold 400, in order to mold the glass of sleeve blank 300 into such a conical shape. The conical shape of portion 345 can be beneficial when the preform produced from sleeve blank 300 is loaded into a draw tower for drawing into a multicore optical fiber. The conical shape may form a draw tip to help initiate the draw process.

FIG. 8J shows yet another embodiment of sleeve blank 300 after it has been melted within mold 400 and assumed the shape (or a partial shape) of interior housing 410. But in the embodiment of FIG. 8J, mold 400 does not comprise rods 420. Therefore, in this embodiment, the glass of sleeve blank 300 is molded to the cylindrical shape of interior housing 410 without any holes formed through sleeve blank 300. In this embodiment, instead of rods 420 forming the core cane holes, the core cane holes are formed by drilling holes in the produced sleeve. Therefore, in this embodiment, the core cane holes are formed in a later step after the molding step. It is also noted that in the embodiment of FIG. 8J, sleeve blank 300 may be formed to have the portion 345 with the conical shape, as depicted in FIG. 8I.

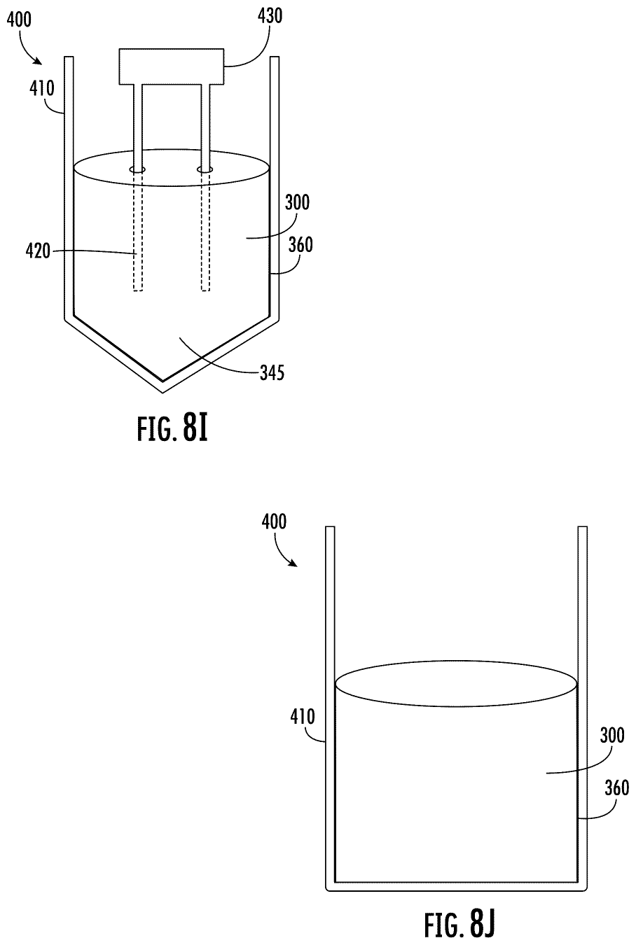

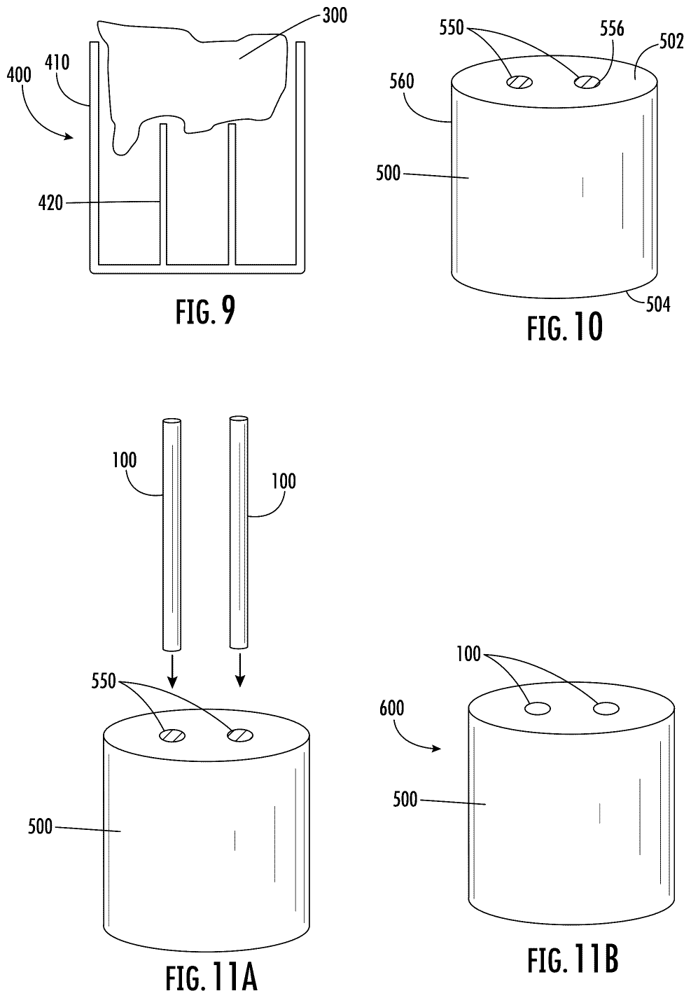

FIG. 9 shows another embodiment in which sleeve blank 300 is heated prior to being positioned within mold 400. For example, sleeve blank 300 may be heated above its softening temperature and then flowed into mold 400 to assume the shape of interior housing 410. As discussed above with regard to the other embodiments disclosed herein, the melted glass of sleeve blank 300 may flow into and around interior housing 410 (and between rods 420) to form a final sleeve with very uniform and smooth dimensions. Sleeve blank 300 may be heated in, for example, another furnace, prior to being positioned with mold 400.

Although FIGS. 8A-8J show one sleeve blank 300 positioned within mold 400, it is also contemplated, in embodiments, that more than one sleeve blank 300 may be positioned within mold 400 at the same time. For example, a plurality of sleeve blanks 300 may be positioned and melted in mold 400 simultaneously such that the melted plurality of sleeve blanks 300 merge together to form a single final sleeve. The plurality of sleeve blanks 300 may be stacked on top of each within mold 400 to form the single final sleeve. In other embodiments, the plurality of sleeve blanks are positioned radially around mold 400. For example, in one exemplary example with reference to FIG. 7, a first sleeve blank may be positioned to the left of rods 420, a second sleeve blank may be positioned between rods 420, and a third sleeve blank may be positioned to the right of rods 420 such that all three sleeve blanks are melted simultaneously within mold 400 to form a single final sleeve. In yet another exemplary example, four sleeve blanks are stacked vertically on top of each within mold 400 and then melted simultaneously within mold 400 to form a single final sleeve.

One or more of the embodiments of the molding process disclosed herein may be combined with one or more other embodiments of the molding process even if not explicitly depicted herein. For example, the portion 345 with the conical shape may be combined with one or more other embodiments, such as the embodiments in which sleeve blank 300 comprises precursor core cane holes 350. Although not specifically depicted, it is also contemplated that support 430 may be used in the embodiments in which sleeve blank 300 is heated prior to being positioned within mold 400. For example, sleeve blank 300 may be heated above its softening temperature and then flowed into mold 400. Then, support 430 with rods 420 connected thereto may be lowered towards the heated glass such that rods 420 puncture through the heated glass.

With reference again to FIG. 1, after sleeve blank 300 is molded within mold 400 to form a more uniform and smooth sleeve, the sleeve is then cooled and removed from mold 400. FIG. 10 shows a final sleeve 500 after the molding process. In particular sleeve 500 is produced after step 13 of process 10. Sleeve 500 comprises very uniform and smooth outer surfaces 560 with low surface roughness. Additionally, sleeve 500 comprise a plurality of core cane holes 550 (in the embodiments that utilize rods 420). As discussed above, the number of core cane holes 550 in sleeve 500 corresponds to the number of rods 420 in mold 400. Core cane holes 550 comprise axial holes that extend through sleeve. The interior surfaces 556 of core cane holes 550 are also uniform and smooth with low surface roughness due to the molding process disclosed herein. In the embodiment of FIG. 10, core cane holes 550 extend an entire length of sleeve 500 from a first surface 502 to an opposing second surface 504 of sleeve 500. However, in other embodiments, core cane holes 550 may extend for less than the entire length of sleeve 500. In these embodiments, a portion of sleeve 500 (that does not comprise core cane holes 550) may be grinded or polished away in order to expose the core cane holes 550.

As also discussed above, in some embodiments, sleeve 500 may not comprise core cane holes 550 after the molding of step 13. Instead, core cane holes 550 may be formed in a later step after the molding and cooling of sleeve blank 300 to form sleeve 500. For example, core cane holes 550 may be formed by drilling holes in the produced sleeve 500.

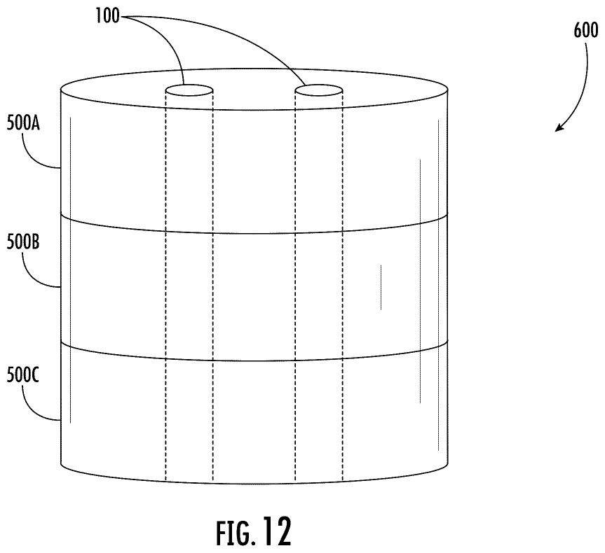

At step 14 of process 10 of FIG. 1, core canes 100 are inserted into core cane holes 550 of sleeve 500 and sealed together to form a multicore optical fiber preform 600, as shown in FIGS. 11A and 11B. In some embodiments, core canes 100 and sleeve 500 are vacuum sealed together. Preform 600 may then be ready for drawing into an optical fiber. As shown in FIG. 12, in embodiments, two or more sleeves 500 may be stacked together to form preform 600. In the embodiment depicted in FIG. 12, three sleeves 500A, 500B, and 500C are stacked together to form preform 600. The stacked sleeves may be vacuum sealed together.

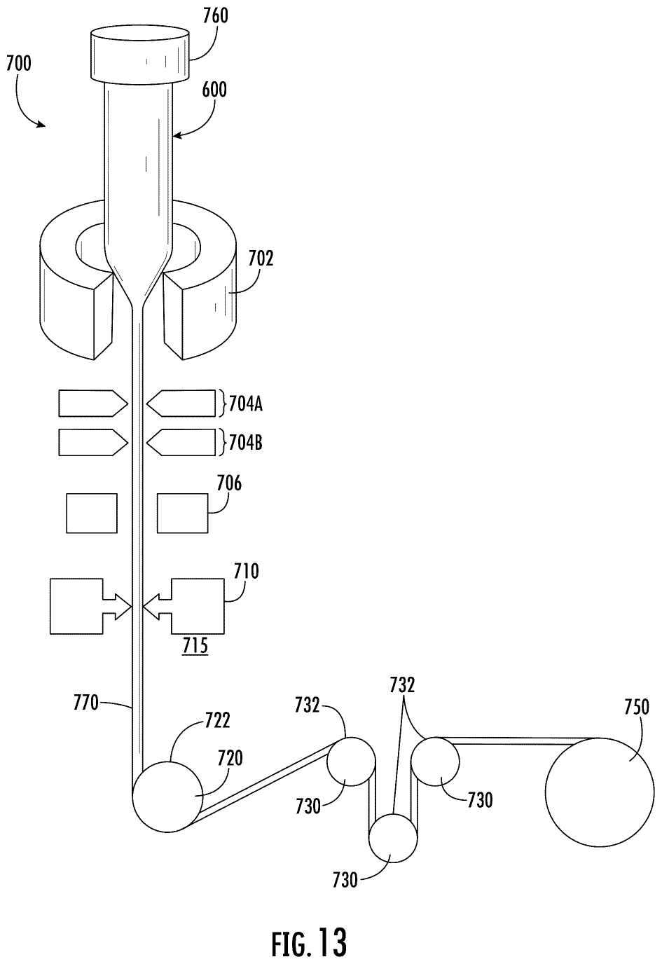

FIG. 13 is a schematic diagram of an exemplary multicore optical fiber drawing system 700 used to draw a multicore optical fiber 770 from preform 600. As shown in FIG. 13, drawing system 100 may comprise a draw furnace 702 for heating an end of preform 600 to its glass melt temperature (e.g., to about 2000° C.), non-contact measurement sensors 704A and 704B for measuring the size of the drawn optical fiber 770 as it exits the draw furnace (e.g., diameter control), a cooling station 706 to cool the drawn optical fiber 770, a coating station 710 that coats the drawn optical fiber 770 with a non-glass coating material 715 to form a protective coating on the fiber, a tensioner 720 to pull (draw) optical fiber 770, guide wheels 730 to guide the drawn optical fiber 770, and a fiber take-up spool (“spool”) 750 to store the drawn optical fiber 770. Tensioner 720 has a surface 722 and guide wheels 730 have surfaces 732 over which the drawn optical fiber 770 passes. Drawing system 700 also includes a preform holder 760, which is located adjacent the top side of draw furnace 702 and holds the preform 600 used to form the multicore optical fiber 770.

According to a first aspect, a method of making a multicore optical fiber is disclosed, the method comprising heating a sleeve blank above its softening temperature and molding the heated sleeve blank within a mold to form a sleeve so that exterior surfaces of the sleeve assume the shape of the mold, the sleeve being formed of silica-based glass and the sleeve comprising a plurality of core cane holes extending within the sleeve, and inserting a core cane through each of the core cane holes, the core canes being formed of silica-based glass and the core canes each comprising a core region.

According to a second, the method of the first aspect, wherein heating the sleeve blank above its softening temperature comprises heating the sleeve blank to a temperature in a range of about 1700° C. and greater.

According to a third aspect, the method of the second aspect, wherein the temperature is in a range from about 1700° C. to about 2000° C.

According to a fourth aspect, the method of any one of the first through third aspects, wherein the mold comprises a plurality of rods and the method further comprises positioning the rods within the heated sleeve blank to form the core cane holes.

According to a fifth aspect, the method of the fourth aspect, wherein a diameter of the rods is substantially the same as a diameter of the core cane holes.

According to a sixth aspect, the method of the fourth or fifth aspects, wherein a number of rods is the same as the number of core cane holes in the sleeve.

According to a seventh aspect, the method of any one of the fourth through sixth aspects, further comprising positioning the sleeve blank within the mold, positioning each of the plurality of rods within a precursor core cane hole in the sleeve blank, and then heating the sleeve blank above its softening temperature.

According to an eighth aspect, the method of any one of the fourth through sixth aspects, further comprising lowering the plurality of rods towards the heated sleeve blank to puncture the heated sleeve blank with the plurality of rods.

According to a ninth aspect, the method of any one of the fourth through eighth aspects, wherein the mold and plurality of rods are formed of graphite.

According to a tenth aspect, the method of any one of the first through ninth aspects, wherein the mold is a furnace.

According to an eleventh aspect, the method of any one of the first through tenth aspects, wherein the core cane holes extend an entire length of the sleeve.

According to a twelfth aspect, the method of any one of the first through tenth aspects, wherein the core cane holes extend less than an entire length of the sleeve.

According to a thirteenth aspect, the method of any one of the first through twelfth aspects, further comprising heating the sleeve blank above its softening temperature prior to positioning the sleeve blank within the mold.

According to a fourteenth aspect, the method of any one of the first through thirteenth aspects, wherein the sleeve blank comprises a plurality of precursor core cane holes extending through the sleeve blank.

According to a fifteenth aspect, the method of the fourteenth aspect, wherein the mold comprises a plurality of rods and the method further comprises positioning each rod within a precursor core cane hole.

According to a sixteenth aspect, the method of any one of the first through thirteenth aspects, wherein the sleeve blank does not comprise a plurality of precursor core cane holes disposed therethrough.

According to a seventeenth aspect, the method of any one of the first through sixteenth aspects, wherein each core cane further comprises a cladding region surrounding the core region.

According to an eighteenth aspect, the method of the seventeenth aspect, wherein the cladding region comprises a trench cladding region.

According to a nineteenth aspect, a method of making a multicore optical fiber prefom, the method comprising heating a sleeve blank above its softening temperature and molding the heated sleeve blank within a mold to form a sleeve so that exterior surfaces of the sleeve assume the shape of the mold, the sleeve being formed of silica-based glass, and forming a plurality of core cane holes within the sleeve.

According to a twentieth aspect, the method of the nineteenth aspect, further comprising inserting a core cane through each of the core cane holes, the core canes being formed of silica-based glass and the core canes each comprising a core region.

According to a twenty-first aspect, the method of the twentieth aspect, wherein each core cane further comprises a cladding region surrounding the core region.

According to a twenty-second aspect, the method of the twenty-first aspect, wherein the cladding region comprises a trench cladding region.

According to a twenty-third aspect, the method of any one of the nineteenth through twenty-second aspects, wherein heating the sleeve blank above its softening temperature comprises heating the sleeve blank to a temperature in a range of about 1700° C. and greater.

According to a twenty-fourth aspect, the method of the twenty-third aspect, wherein the temperature is in a range from about 1700° C. to about 2000° C.

According to a twenty-fifth aspect, the method of any one of the nineteenth through twenty-fourth aspects, wherein the mold is a furnace.

According to a twenty-sixth aspect, the method of any one of the nineteenth through twenty-fifth aspects, wherein the core cane holes extend an entire length of the sleeve.

According to a twenty-seventh aspect, the method of any one of the nineteenth through twenty-sixth aspects, wherein the core cane holes extend less than an entire length of the sleeve.

According to a twenty-eighth aspect, the method of any one of the nineteenth through twenty-seventh aspects, further comprising heating the sleeve blank above its softening temperature prior to positioning the sleeve blank within the mold.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. A method of making a multicore optical fiber prefom, the method comprising:
heating a sleeve blank above its softening temperature and molding the heated sleeve blank within a mold to form a sleeve so that exterior surfaces of the sleeve assume the shape of the mold, the sleeve being formed of silica-based glass and the sleeve comprising a plurality of core cane holes extending within the sleeve; and
inserting a core cane through each of the core cane holes, the core canes being formed of silica-based glass and the core canes each comprising a core region.

2. The method of claim 1, wherein heating the sleeve blank above its softening temperature comprises heating the sleeve blank to a temperature in a range of about 1700° C. and greater.

3. The method of claim 2, wherein the temperature is in a range from about 1700° C. to about 2000° C.

4. The method of claim 1, wherein the mold comprises a plurality of rods and the method further comprises positioning the rods within the heated sleeve blank to form the core cane holes.

5. The method of claim 4, wherein a diameter of the rods is substantially the same as a diameter of the core cane holes.

6. The method of claim 4, wherein a number of rods is the same as the number of core cane holes in the sleeve.

7. The method of claim 4, further comprising positioning the sleeve blank within the mold, positioning each of the plurality of rods within a precursor core cane hole in the sleeve blank, and then heating the sleeve blank above its softening temperature.

8. The method of claim 4, further comprising lowering the plurality of rods towards the heated sleeve blank to puncture the heated sleeve blank with the plurality of rods.

9. The method of claim 4, wherein the mold and plurality of rods are formed of graphite.

10. The method claim 1, wherein the mold is a furnace.

11. The method of claim 1, wherein the core cane holes extend an entire length of the sleeve.

12. The method of claim 1, wherein the core cane holes extend less than an entire length of the sleeve.

13. The method of claim 12, further comprising heating the sleeve blank above its softening temperature prior to positioning the sleeve blank within the mold.

14. The method of claim 1, wherein the sleeve blank comprises a plurality of precursor core cane holes extending through the sleeve blank.

15. The method of claim 14, wherein the mold comprises a plurality of rods and the method further comprises positioning each rod within a precursor core cane hole.

16. The method of claim 1, wherein the sleeve blank does not comprise a plurality of precursor core cane holes disposed therethrough.

17. The method of claim 1, wherein each core cane further comprises a cladding region surrounding the core region.

18. The method of claim 17, wherein the cladding region comprises a trench cladding region.

19. A method of making a multicore optical fiber prefom, the method comprising:
heating a sleeve blank above its softening temperature and molding the heated sleeve blank within a mold to form a sleeve so that exterior surfaces of the sleeve assume the shape of the mold, the sleeve being formed of silica-based glass; and
forming a plurality of core cane holes within the sleeve.

20. The method of claim 19, further comprising inserting a core cane through each of the core cane holes, the core canes being formed of silica-based glass and the core canes each comprising a core region.

21. The method of claim 19, wherein heating the sleeve blank above its softening temperature comprises heating the sleeve blank to a temperature in a range of about 1700° C. and greater.
